(19) United States
(12) Patent Application Publication
(10) Pub. No.: US 2003/0046118 A1
(43) Pub. Date: Mar. 6, 2003

(54) Portal architecture for mobile platforms

(76) Inventor: Mary E. O'Donnell, Issaquah, WA (US)

Correspondence Address: Mark D. Elchuk and Kelly K. Burris, Harness, Dickey & Pierce, P.L.C., Suite 400, 5445 Corporate Drive, Troy, MI, 48098-2683, US

(21) Appl. No.: 10/103,484

(22) Filed: Mar. 21, 2002

Related U.S. Application Data
(60) Provisional application No. 60/316,741, filed on Aug. 31, 2001.

(51) Int. Cl. G06F 17/60

(52) U.S. Cl. 705/5

(57) ABSTRACT

A portal architecture system and method is provided that includes a central content management system that communicates destination driven and travel information for mobile clients (i.e., individuals) through a plurality of interfaces. The interfaces comprise an in-flight Internet portal where the mobile client can access information regarding his/her destination or a specified destination in addition to other more general information while in-transit; a customer interface where the mobile client can access airline specific travel information; and a ground Internet portal where the mobile client can perform extensive travel planning while in-transit. Further, the mobile client can customize the interfaces according to personal preferences, and the resulting personal profiles are coordinated across all interfaces by the content management system.

### CROSS-REFERENCE TO RELATED APPLICATIONS

This application is based upon Provisional Patent Application, Serial No. 60/316,741, entitled “Portal Architecture for Mobile Platforms,” filed Aug. 31, 2001, the contents of which are incorporated herein by reference in their entirety and continued preservation of which is requested.

### FIELD OF THE INVENTION

The present invention relates generally to portal architectures for networked computer systems and more particularly to an architecture that automatically repopulates content based on a travel destination of a mobile client, and further coordinates the content across a plurality of portals.

### BACKGROUND OF THE INVENTION

Networked computer systems that provide specific content to a user or group of users are generally ground-based, i.e. both the computer system (server) and the user (client) are located on land. Generally, bidirectional communication takes place from one ground-based server, or a plurality thereof, to and from a ground-based client, or a plurality thereof. In some instances the client is mobile and therefore uses wireless technology through a hand-held PDA (personal digital assistant) or a laptop computer to communicate with the server(s). Unfortunately, wireless mobile access has limited capacity and is of a relatively narrow bandwidth, resulting in longer waiting periods and insufficient data access. If there exist a large number of mobile clients, these problems are only further magnified. Moreover, access to data from a server by mobile clients can be relatively expensive and is in many instances cost prohibitive for the casual user.

With wireless mobile access of the known art, there often exist undesirable interruptions in access. If, for example, a mobile client is traveling through a geographical area where the signal strength is weak, or the signal is temporarily interrupted, Internet access may be extremely slow or interrupted in its entirety. If the mobile client is traveling on a commercial airline, access is further limited to the times during which the wireless signal will not interfere with the suite of electronics on-board a commercial aircraft. Typically, access times are limited to when the aircraft is at cruising altitude, and accordingly, access is prohibited during taxi, take-off, climb to altitude, descent to landing, and landing.

When data is accessed through the Internet, the server can provide specific content to a client using a “portal,” or a web site that is a starting point for users when first connected or which is visited as an anchor site. Two primary types of portals exist, namely, general portals and specialized or niche portals. General portals include sites such as Yahoo® or Excite^{SM}, where a wide variety of information can be searched and accessed, and niche portals include sites such as garden.com (for gardeners) and traveler.com (for travelers) where information tailored to a specific group of users is available. In limited instances, users can further customize or personalize the content so that the portal is unique to the individual or group of individuals having access.

With mobile clients, however, there is a clear absence of niche portals that are tailored to the travel needs of the client during periods of travel. No portals exist in the known art that automatically provide content based on the destination of the client, further while the client is in transit to that destination. For example, users of traveler.com must browse a list of destinations and choose their destination city to access information regarding that destination. The portal has no knowledge of the user's destination, or destinations, and further, the information regarding the destination is limited. For instance, no information is available regarding business or sports news for any given destination. Only limited information such as hotels, restaurants, and shopping is available to the client. In addition, only a limited number of destinations are available, and consequently, a client headed for an unlisted destination must search other sites for the desired information, often resulting in a time consuming and cumbersome task for the client. Moreover, the client cannot personalize or customize the portal according to their preferences.

Further to the need for in-transit niche portals, no ground-based portals exist that are directed towards travel planning and that are coordinated with the needed in-transit portals. If a mobile client invests time customizing an in-transit portal and further establishing a personal profile such as bookmarks and layout/content settings for the portal, the personal profile should be synchronized with a counterpart ground-based portal, so that the client does not have to create and save their preferences more than once.

With mass transit clients, such as those traveling via commercial airline, ship, bus, train, or other transit modes, there does not currently exist a portal to which the user can logon in-transit and access, for example, airline-specific travel information. If such a portal existed, it would be highly desirable to coordinate this portal with the needed in-transit and ground-based portals to provide a comprehensive travel tool for the mobile client.

Accordingly, there remains a need in the art for an Internet portal architecture that is directed to mobile clients where the user can quickly and efficiently access destination driven information while in-transit and while ground-based.

### SUMMARY OF THE INVENTION

In one preferred form, the present invention provides an Internet portal architecture having a central server in communication with one or more clients. The central server, hereinafter referred to as the “content management system,” provides and manages destination driven information (e.g., travel advisories, customs information) for each of three distinct client interfaces, namely, an in-transit portal, a ground-based portal, and a customer interface.

The content management system stores and organizes the destination driven information into specific business travel and leisure travel topic areas. Additional general topic areas including, but not limited to, business, news, weather, sports, entertainment, shopping, and culture are also stored and provided by the content management system. The content management system comprises an on-board server that physically co-exists with the client on a particular travel platform, e.g. commercial aircraft, and at least one ground-based server that supplements content to the content management system. Predetermined destination information is cached onto the on-board server for quick and efficient access by the mobile client while in transit. If the mobile client requests information which is not cached onto the on-board server, the content management system submits the request to the ground-based server using satellite data links, and the information is ultimately transferred to the in-transit portal. Because the connections are broadband, large quantities of data at relatively high data rates are available to the mobile client during all phases of travel.

The content management system automatically populates the in-transit portal with specific information regarding the destination of the mobile client. As the client is traveling to a particular destination, customized site content pertaining to that destination is automatically presented along with additional topic areas more general in nature to the in-transit portal. Similarly, the ground-based portal presents content more specifically for the purpose of travel planning. The customer interface provides customer-specific travel information to the mobile client, such as entertainment, fares, and catalogs. Further, the customer interface is accessed through a logon from the in-transit portal.

Additionally, each client is able to personalize their individual portals using preference profiles, which include custom bookmarks and layout/content settings. For example, the client can edit or turn-off unwanted content and save the layout settings to be the same across portals during future access. Specifically, the preferences are shared between the in-transit portal and the ground-based portal so that the client does not have to re-enter their preferences for each portal, thereby maintaining consistency and a user-friendly interface.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a simplified block diagram illustrating the content management system in communication with the portals of the present invention; and

FIG. 2 is a simplified block diagram illustrating the content management system in communication with the servers of the present invention.

### DETAILED DESCRIPTION OF THE PREFERRED EMBODIMENT

The following description of the preferred embodiments is merely exemplary in nature and is in no way intended to limit the invention, its application, or uses.

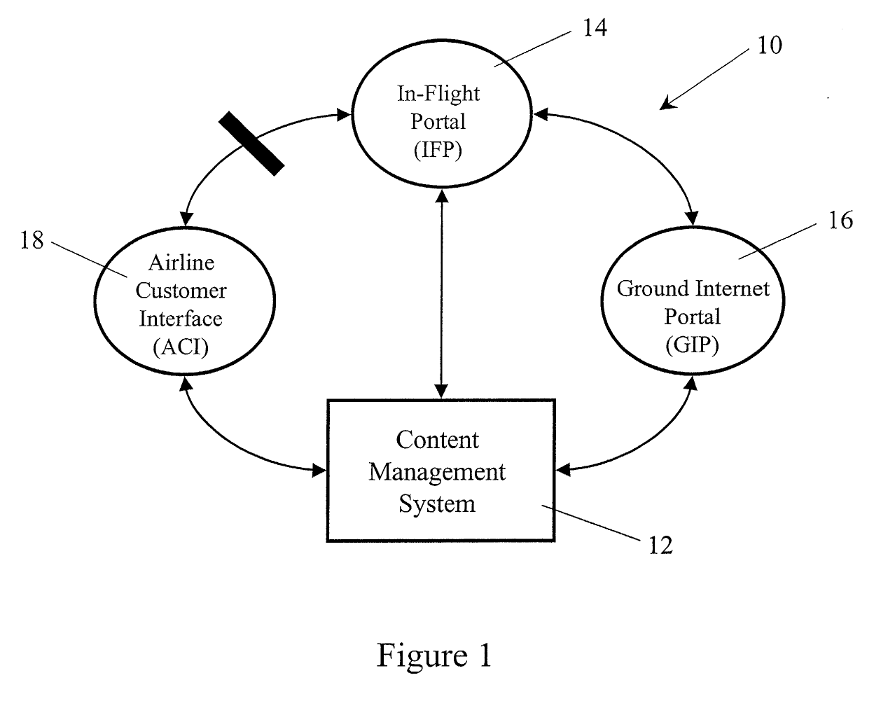

Referring to FIG. 1, the preferred embodiment of the portal architecture of the present invention is illustrated and generally indicated by reference numeral 10. Portal architecture 10 comprises a content management system 12 in communication with three (3) primary portals, namely, an in-flight Internet portal (IFP) 14, a ground Internet portal (GIP) 16, and an airline customer interface (ACI) 18. Generally, content management system 10 stores all destination and travel information and communicates the same with each portal according to the function of each. The IFP 14 is an Internet portal that provides mobile clients with detailed destination information, along with other more general information, while the client is in transit to that destination. The GIP 16 is an Internet portal that provides mobile clients with travel planning information and is coordinated with the IFP 14 so that each interface is substantially similar to the mobile client. Further, the ACI 18 is a portal that provides mobile clients with airline-specific travel information.

Although the following description is directed to a mobile client traveling via commercial airline, the invention is also applicable to other modes of mass transit such as ship, train, bus, and others, and the reference to airlines should not be construed as limiting the applicability of the invention to only airlines. Accordingly, the “in-flight Internet Portal” (IFP) 14 is also referred to herein as an “in-transit interface” to encompass additional modes of transportation to which the present invention may be applied.

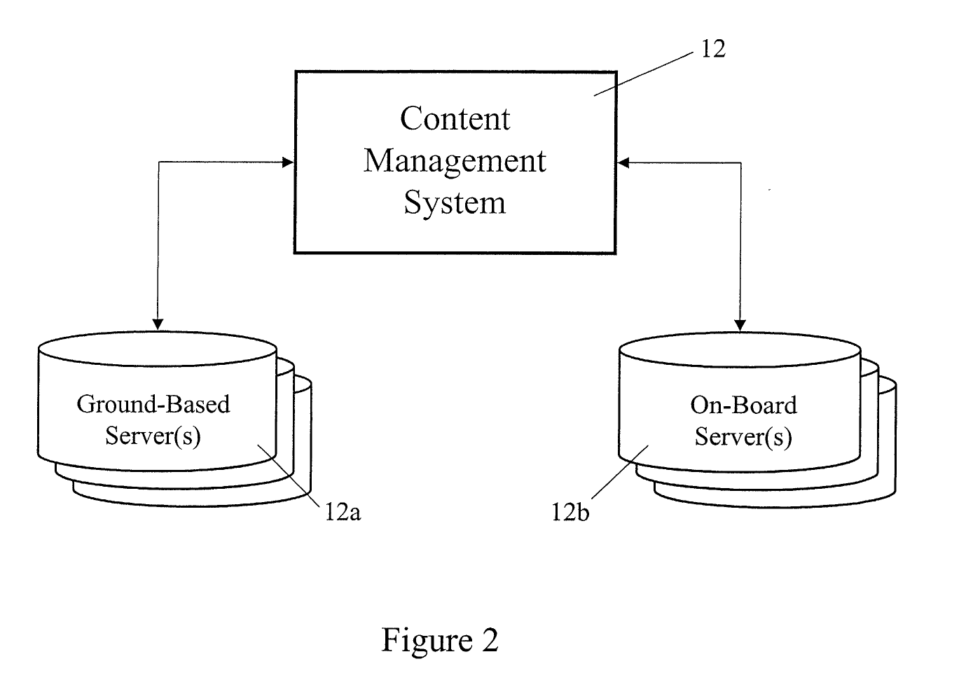

The content management system 12 may include a single server or a plurality of servers, depending on the cumulative demand from the mobile clients. Referring to FIG. 2, content management system 12 preferably comprises a ground-based server 12a and an on-board server 12b. The ground-based server 12a is physically located on the ground and is accessed via satellite data links, whereas the on-board server 12b is physically located on-board the aircraft with the mobile client. The on-board server 12b stores predetermined travel and destination information that is tailored to the mobile client. To complement the on-board server 12b, the ground-based server 12a is employed to provide for access on-demand to Internet data that is requested by the client yet which is not stored on the on-board server 12b. For example, if the client requests information that is not predetermined and stored on the on-board server 12b, the information is accessed using satellite data links to the ground-based server 12a and subsequently presented to the mobile client.

The predetermined travel and destination information is contained within a set of HTML pages that are stored on the on-board server for quick and efficient access by the clients. The HTML pages are updated via a manual cache refresh using a CD ROM or other electronic storage media. Alternatively, the HTML pages are updated on-demand using satellite data links from the on-board server to the ground-based servers while in-flight.

Content management system 12 stores all information that is communicated amongst each of the portals. Generally, the information comprises destination driven flight facts, personalization data according to individual client preferences, and content of a more general nature. The destination driven flight facts comprise information such as flight connection information, destination weather and news, travel advisories, customs information and requirements, and other in-depth travel-oriented information. Accordingly, the mobile client is able to access comprehensive information regarding their particular destination while in-transit, resulting in a more time efficient and informed client, whether for business or for leisure. For example, if the weather is causing delays at the destination, the client is able to access this information while in-transit and can make alternate travel arrangements if necessary. The client does not have to manually search for weather advisory information, rather, the content management system automatically provides the information to the client.

The in-flight Internet portal (IFP) 14 is served travel and destination flight facts in addition to more general content from the content management system 12. Both predetermined travel and destination information from the on-board server and on-demand information from the ground-based servers of content management system 12 are provided to the IFP 14. A broadband connection is provided between IFP 14 and content management system 12 such that large quantities of data can be accessed quickly by the mobile client.

Generally, the pre-determined destination driven content provided to IFP 14 comprises destination and flight connection information, national and international weather, travel advisories, customs information and requirements, and other in-depth travel-oriented information. IFP 14 is initially driven by the destination of the mobile client, however, the client may specify a different destination according to their particular needs. For example, if the client is traveling to Frankfurt but desires information regarding London, the client simply defines London as a destination and the content throughout IFP 14 is automatically populated with travel and other in-transit information relating specifically to London (and Europe). The mobile client can also request additional information through IFP 14 that is not pre-determined destination information, such as any information obtainable through a standard Internet browser. As previously set forth, this “on-demand” Internet information is obtained through satellite data links to ground-based servers.

In addition to real-time Internet access, the portal architecture of the present invention further provides for access to corporate intranets. If the mobile client is a business traveler and his/her company has a corporate intranet, the IFP 14 is capable of accessing the corporate intranet for the mobile client while in transit. The intranet is similarly accessed through satellite data links to ground-based servers.

IFP 14 further provides for personalization of the portal to include custom bookmarks and layout/content settings. For example, the client can edit or turn off unwanted content that is automatically provided by content management system 12. The personal settings of the client can also include such information as hotel, airline, and rental car preferences, and frequent flyer and hotel member numbers. Moreover, the personal settings established by the client are stored by content management system 12 and are accordingly shared with the ground Internet portal (GIP) 16 so that the client does not have to create and save their preferences more than once.

Preferably, IFP 14 is a fee-based portal, which requires a logon ID and password to be entered by the client. Accordingly, logon information is stored in a database located within the content management system 12 and is updated with either a CD ROM or other electronic storage media to the on-board server or on demand through satellite data links to the ground-based servers.

The ground Internet portal (GIP) 16 is provided general travel planning content by the content management system 12. Accordingly, ground-based clients access GIP 16 prior to or after travel where the IFP 14 is accessed. Generally, GIP 16 provides sophisticated business and leisure travel planning information in addition to other more general information for planning trips and exploring travel options and destination information. As previously set forth, the personal settings of the client from the IFP 14 are maintained across the GIP 16 so that the client has a similar look and feel whether in-transit or ground-based.

Both the IFP 14 and the GIP 16 further provide a search and book super agent, hereinafter referred to as an “agent bot,” which finds and reserves the best bookings in hotels, cars, flights, and package deals according to the search parameters of the client. If, for example, a mobile client is looking ahead to future travel and wants to book reservations for airline tickets, a hotel, and/or a rental car while in transit, the client simply enters the dates and destination into either the IFP 14 or the GIP 16, and the agent bot returns the best selections to the client. If the client has stored personal preferences in either the IFP 14 or the GIP 16, the agent bot uses the preferences as additional parameters for its search. The agent bot goes out across the Internet and accesses a variety of web sites to gather content that meets the dates, destination, and other personal preferences of the client. The agent bot then organizes and presents the content to the client through the respective portal, and the client can then confirm any of the reservations that are desired.

The airline customer interface (ACI) 18 is served destination driven flight facts from the content management system 12. In turn, the ACI 18 is accessed once a user connects with the system and launches a browser. Generally, ACI 18 provides the in-flight client with airline-branded information and specified content. Typical content includes, but is not limited to, music, catalogs and magazines, entertainment, as well as airline, flight, and destination information. Further, the content can be customized according to the needs of the particular airline or mass transit carrier.

Content management system 12 further tracks client activity and stores the information communicated from each of the IFP 14, the GIP 16, and the ACI 18, in a customer database which is a part of the content management system 12. The information is then used to further tailor the content management system 12 to provide the types of information most often requested by mobile clients. For example, if a particular web site is frequently visited by a large number of mobile clients and the site is accessed through satellite data links to the ground-based servers, the URL for the web site is automatically cached and periodically updated on the on-board server so that the satellite data link is not required as often. As a result, Internet sites most frequently accessed by mobile clients are accessed more efficiently.

The customer database stores all logon information and access times to support a billing system with the fee-based embodiment of IFP 14. Customer database information can further be downloaded from the on-board server to ground-based servers on an as-needed basis through satellite data links.

Each of the portals, namely IFP 14, GIP 16, and ACI 18 support client-side scripting (e.g. Java Script) and executable code (e.g. Java) so that the client can interact with the portal content and the content can be updated automatically depending on the destination and inputs/requests of the client.

The servers for content management system 12 can run on a variety of operating systems, including but not limited to, NT, UNIX, and Linux. In addition, a variety of web server software can be employed, including but not limited to MS Internet Information Server, Apache Web Server, and Real Networks.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A portal architecture system that automatically provides specific Internet content to a mobile client, the system comprising:
a content management system comprising the specific Internet content;
a customer interface in communication with the content management system;
an in-transit interface in communication with the content management system and the customer interface; and
a ground-based interface in communication with the content management system and the in-transit interface,
wherein the content management system automatically sends the specific Internet content to the customer interface, the in-transit interface, and the ground-based interface according to a destination of the mobile client.

2. The system of claim 1, wherein the content management system further comprises:
(a) at least one in-transit server; and
(b) at least one ground-based server,
wherein the in-transit server provides predetermined content to the content management system and the ground-based server provides Internet content on-demand to the content management system.

3. The system of claim 2, wherein the ground-based server further provides intranet content on-demand to the content management system.

4. The system of claim 2, wherein the ground-based server communicates with the in-transit server using satellite data links.

5. The system of claim 1, wherein the content management system further comprises a database that stores information communicated from the customer interface, the in-transit interface, and the ground-based interface.

6. The system of claim 1, wherein the content management system further comprises mobile client preferences.

7. The system of claim 6, wherein the mobile client preferences are specified by the mobile client.

8. The system of claim 6, wherein the content management system supplies the mobile client preferences to the in-transit interface and the ground-based interface.

9. The system of claim 1, wherein the architecture system further comprises an in-transit logon such that the mobile client can access the portal from the customer interface.

10. The system of claim 1, wherein the in-transit interface and the ground-based interface further comprise an agent bot that searches, identifies, and presents travel reservations to the mobile client.

11. The system of claim 10, wherein the mobile client is able to book the travel reservations presented by the agent bot via the in-transit interface.

12. The system of claim 10, wherein the mobile client is able to book the travel reservations presented by the agent bot via the ground-based interface.

13. The system of claim 1, wherein the communication between the in-transit interface and the content management system is broadband.

14. The system of claim 1, wherein the in-transit interface further comprises a logon for access to the specific Internet content by the mobile client.

15. The system of claim 14, wherein access to the in-transit interface by the mobile client is fee-based.

16. A portal architecture system that automatically provides specific Internet content to a mobile client, the system comprising:
a content management system comprising the specific Internet content; and
an in-transit interface in communication with the content management system,
wherein the content management system automatically sends the specific Internet content to the in-transit interface according to a destination of the mobile client.

17. The system of claim 16, wherein the content management system further comprises:
(c) at least one in-transit server; and
(d) at least one ground-based server,
wherein the in-transit server provides predetermined content to the content management system and the ground-based server provides Internet content on-demand to the content management system.

18. The system of claim 17, wherein the ground-based server further provides intranet content on-demand to the content management system.

19. The system of claim 17 wherein the ground-based server communicates with the in-transit server using satellite data links.

20. The system of claim 16, wherein the content management system further comprises a database that stores information communicated from the in-transit interface.

21. The system of claim 16, wherein the content management system further comprises mobile client preferences.

22. The system of claim 21, wherein the mobile client preferences are specified by the mobile client.

23. The system of claim 16, wherein the in-transit interface further comprises an agent bot that searches, identifies, and presents travel reservations to the mobile client.

24. The architecture system of claim 23, wherein the mobile client is able to book the travel reservations presented by the agent bot via the in-transit interface.

25. The system of claim 16, wherein the communication between the in-transit interface and the content management system is broadband.

26. The system of claim 16, wherein the in-transit interface further comprises a logon for access to the specific Internet content by the mobile client.

27. The system of claim 26, wherein access to the in-transit interface by the mobile client is fee-based.

28. In a portal architecture system comprising a content management system in communication with mobile client interfaces, a method of automatically providing specific Internet content to a mobile client, the method comprising the steps of:
(a) storing the destination of the mobile client in the content management system;
(b) storing the specific Internet content in the content management system, the specific Internet content relating to information concerning the destination of the mobile client;
(c) receiving from one of the mobile client interfaces a logon to the content management system; and
(d) automatically sending the specific Internet content to the mobile client interface while the mobile client is in transit so that the specific Internet content can be accessed by the mobile client prior to arrival at the destination.

29. The method of claim 28, further comprising the steps of:
(a) receiving from the mobile client a request for Internet information not contained within the content management system after step (b);
(b) sending the request to a ground-based server through satellite data links;
(c) receiving the requested Internet information from the ground-based server through satellite data links; and
(d) sending the requested Internet information to the mobile client.

30. The method of claim 28, further comprising the steps of:
(a) receiving personal preference information from the mobile client after step (b);
(b) storing the personal preference information on the content management system; and
(c) providing the personal preference information to a plurality of mobile client interfaces.

31. The method of claim 28, further comprising the steps of:
(a) receiving a request for reservation information from the mobile client after step (b);
(b) sending a bot to access web sites and gather reservation information related to the request for reservation information; and
(c) presenting the requested reservation information to the mobile client via one of the mobile client interfaces.

32. The method of claim 31, wherein the mobile client books reservations through the mobile client interface.
